(19) United States
(12) Patent Application Publication
(10) Pub. No.: US 2026/0035062 A1
(43) Pub. Date: Feb. 5, 2026

(54) CELLULAR ACOUSTIC ABSORPTION STRUCTURE INCLUDING AT LEAST ONE PARTITIONING ENCLOSURE POSITIONED IN A CELL OF THE CELLULAR STRUCTURE

(71) Applicant: Airbus Operations SAS, TOULOUSE (FR)

(72) Inventors: Arnaud BOURHIS, TOULOUSE (FR); Benoit PRZYBYLA, TOULOUSE (FR)

(21) Appl. No.: 19/287,920

(22) Filed: Aug. 1, 2025

(30) Foreign Application Priority Data
Aug. 5, 2024 (FR) FR2408644

(51) Int. Cl. B64C 1/40; B32B 3/12; B64C 1/00

(52) U.S. Cl. CPC B64C 1/40; B32B 3/12; B32B 2307/102; B32B 2605/18; B64C 2001/0072

(57) ABSTRACT

An acoustic absorption structure including at least one cellular structure between an acoustically resistive layer and a reflective layer. The cellular structure includes a first face in contact with the acoustically resistive layer, a second face in contact with the reflective layer, and a multitude of cells each discharging at the level of the first and second faces, each cell being delimited by at least one partition, wherein the cellular structure comprises at least one partitioning enclosure positioned in one of the cells of the cellular structure and connected to at least one partition delimiting the cell. The partitioning enclosure separates an interior zone inside the partitioning enclosure and an exterior zone situated in the cell and outside the partitioning enclosure. The partitioning enclosure includes at least one through-orifice configured so that the interior and exterior zones communicate.

### CROSS-REFERENCES TO RELATED APPLICATIONS

This application claims the benefit of French Patent Application Number FR2408644 filed on Aug. 5, 2024, the entire disclosures of which are incorporated herein by way of reference.

### FIELD OF THE INVENTION

The present application relates to a cellular acoustic absorption structure including at least one partitioning enclosure positioned in a cell of the cellular structure and to an aircraft including at least one such acoustic absorption structure.

### BACKGROUND OF THE INVENTION

In one prior art embodiment, an aircraft propulsion assembly comprises a nacelle and a bypass turbojet positioned inside the nacelle, which has at the rear a primary jet pipe through which the burnt gases resulting from combustion are evacuated. This primary jet pipe comprises, at the level of its skin, an acoustic absorption structure to attenuate noise in a plurality of frequency bands, such as those of noise associated with combustion (300-1000 Hz) and those of noise associated with the operation of the turbine (greater than or equal to 4000 Hz), for example.

In a first embodiment, an acoustic absorption structure comprises at least one cellular structure positioned between an acoustically resistive layer in contact with a medium in which acoustic waves propagate and a reflective layer. This embodiment enables a quarter-wave resonator to be obtained that is adapted to attenuate sound waves at high frequencies. In this embodiment, the range of frequencies of the attenuated sound waves depends on the height of cells of the cellular structure.

In a second embodiment seen in FIG. 1 and described in the document FR094668, an acoustic absorption structure 10 comprises first and second cellular structures 12, 14 positioned between an acoustically resistive layer 16 in contact with a medium in which acoustic waves propagate and the reflective layer 18. This acoustic absorption structure 10 comprises a separation layer 20 between the first and second cellular structures, 12, 14, the first cellular structure 12 being situated between the acoustically resistive layer 16 and the separation layer 20, the second cellular structure 14 being situated between the reflective layer 18 and the separation layer 20.

In this second embodiment, the separation layer 20 comprises orifices 22 enabling the cells of the first cellular structure 12 to communicate with those of the second cellular structure 14, each orifice 22 being extended by a tube 24 positioned in the second cellular structure 14.

The acoustic absorption structure 10 enables two types of resonators to be obtained, a Helmholtz type first resonator at the level of the cells of the first cellular structure 12 adapted to attenuate low-frequency sound waves and a quarter-wave type second resonator at the levels of the cells of the second cellular structure 14 adapted to attenuate high-frequency sound waves.

In the second embodiment, each tube 24 is connected by a connection 24.1 to the separation layer and the first and second cellular structures 12, 14 are connected to the separation layer 20 by connections 12.1, 14.1. The cells of the first and second cellular structures 12, 14 must be perfectly aligned so that each cell of the first cellular structure 12 communicates with only one cell of the second cellular structure 14.

Although this second embodiment enables attenuation of sound waves over wider frequency ranges it is not entirely satisfactory because the large number of connections leads to an increased mass of the acoustic absorption structure 10 and complicates its method of manufacture. The latter method is all the more complex in that the cells of the first and second cellular structures must be perfectly aligned to obtain optimal operation. Finally, shaping the acoustic absorption structure 10 with a curved profile proves difficult given the connections 12.1, 14.1 that connect the ends of the walls delimiting the cells of the first and second cellular structures 12, 14 to the separation layer 20.

The present invention is intended to remedy some or all of the disadvantages of the prior art.

### SUMMARY OF THE INVENTION

To this end, the invention has for an object an acoustic absorption structure comprising at least one cellular structure between an acoustically resistive layer and a reflective layer, the cellular structure comprising a first face in contact with the acoustically resistive layer, a second face in contact with the reflective layer, and a multitude of cells, each discharging at the level of the first and second faces, each cell being delimited by at least one partition.

According to the invention, the cellular structure comprises at least one partitioning enclosure positioned in one of the cells of the cellular structure and connected to at least one partition delimiting the cell, the partitioning enclosure separating an interior zone inside the partitioning enclosure and an exterior zone situated in the cell and outside the partitioning enclosure, the partitioning enclosure including at least one through-orifice configured so that the interior and exterior zones communicate.

This solution makes it simple to create in a cell a plurality of zones, each of which forms a resonator configured to attenuate acoustic waves at frequencies in a given range of frequencies, thereby contributing to acoustic attenuation over a wide frequency spectrum.

In accordance with another feature, each partitioning enclosure comprises:
at least one tubular wall substantially parallel to the partition direction, connected to at least one partition delimiting the cell, which extends between first and second ends,
a first transverse wall connected in fluid-tight manner to the tubular wall at the level of the first end,
at least one second transverse wall connected in fluid-tight manner to the tubular wall at the level of the second end,
the through-orifice being situated at the level of the first transverse wall, and the first and second transverse walls are spaced from the acoustically resistive layer and the reflective layer.

In accordance with another feature, the tubular wall has an exterior cross section smaller than the interior cross section of the cell and greater than or equal to 75% of the interior cross section of the cell.

In accordance with another feature, the partitioning enclosure comprises a pipe that has a first end connected to the first transverse wall around the through-orifice and a second end at a distance from the first transverse wall, the pipe having an inside diameter substantially equal to that of the through-orifice.

In accordance with another feature, the pipe and the through-orifice have a passage section less than or equal to 25% of the interior cross section of the tubular wall.

In accordance with another feature, each cell is delimited by a plurality of partitions and the partitioning enclosure is connected to at the most two partitions delimiting the cell.

In accordance with another feature, the tubular wall comprises at least one flat configured to be pressed against and connected to a partition of the cellular structure.

In accordance with another feature, the tubular wall has a constant exterior cross section between the first and second transverse walls and includes a curved main part that has an approximately circular arc section, a main flat and two secondary flats positioned on respective opposite sides of the main flat connecting the latter to the curved main part.

In accordance with another feature, each cell has a hexagonal section inscribed in a cell diameter circle. Additionally, the curved main part and the two secondary flats are spaced from the partitions of the cell by a distance between 5% and 50% of the cell diameter.

In accordance with another feature, the first and second transverse walls are oriented toward the reflective layer and the acoustically resistive layer, respectively.

In accordance with another feature, the first and second transverse walls are oriented toward the acoustically resistive layer and the reflective layer, respectively.

The invention also has for an object an aircraft comprising at least one acoustic absorption structure having any of the above features.

### BRIEF DESCRIPTION OF THE DRAWINGS

Other features and advantages will emerge from the following description of the invention given by way of example only and with reference to the appended drawings, in which:

FIG. 1 is a diagrammatic section of an acoustic absorption structure depicting a prior art embodiment,

FIG. 2 is a side view of an aircraft embodying the invention,

FIG. 3 is a longitudinal section of a part of an aircraft propulsion assembly embodying the invention,

FIG. 4 is a view from above of a part of a cellular structure depicting an embodiment of the invention,

FIG. 5 is a perspective view as seen at a first angle of a partitioning enclosure positioned in a mold depicting one embodiment of the invention,

FIG. 6 is a perspective view as seen from a second angle of the partitioning enclosure and the mold seen in FIG. 5,

FIG. 7 is a section of a partitioning enclosure depicting an embodiment of the invention,

FIG. 8 is a perspective view of a partitioning enclosure depicting an embodiment of the invention,

FIGS. 9A-9C are diagrammatic representations of the various steps of mounting a partitioning enclosure in a cell of a cellular structure depicting an embodiment of the invention,

FIG. 10 is a cross section of an acoustic absorption structure depicting a first embodiment of the invention,

FIG. 11 is a section of an acoustic absorption structure depicting a second embodiment of the invention.

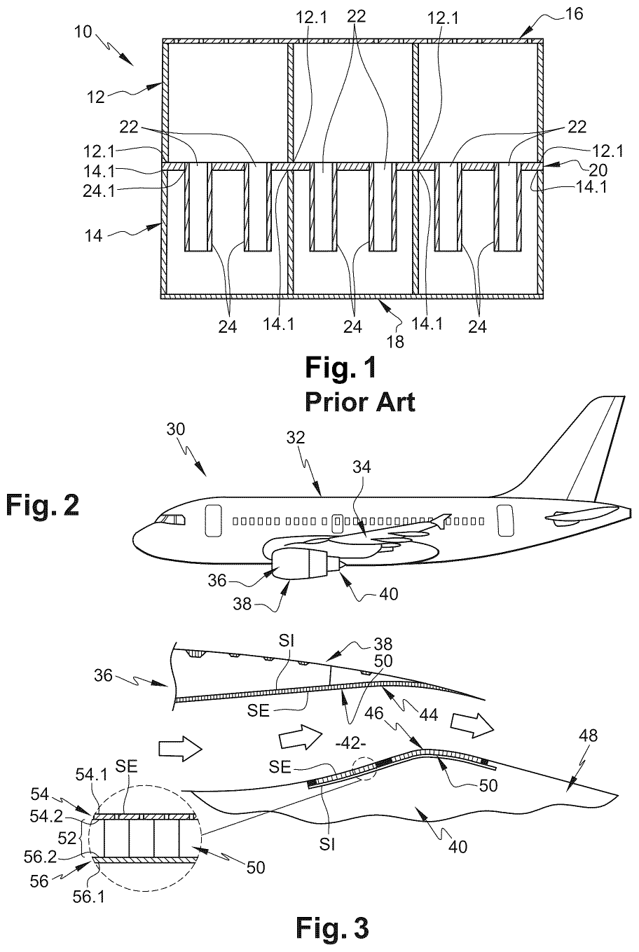

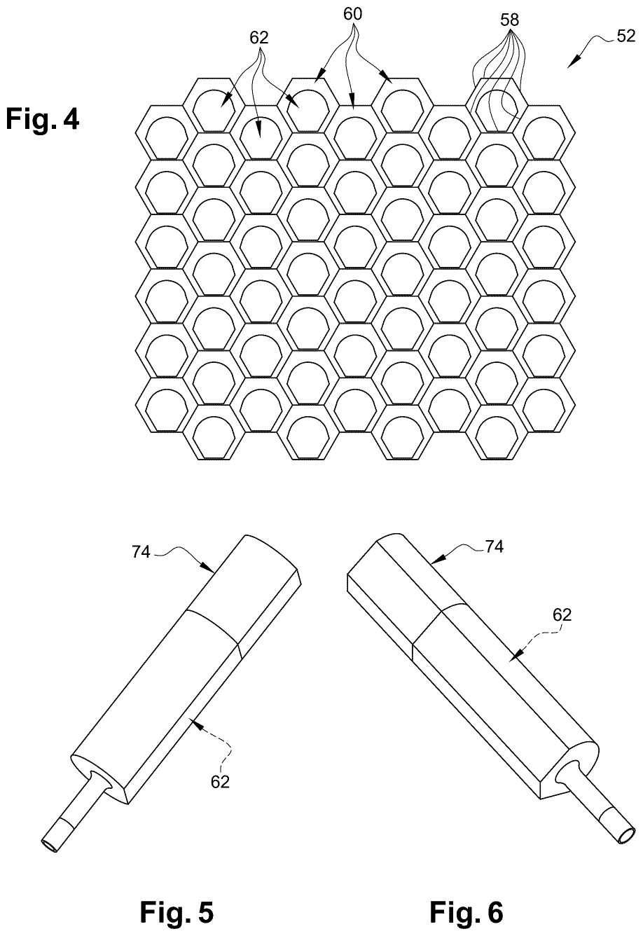

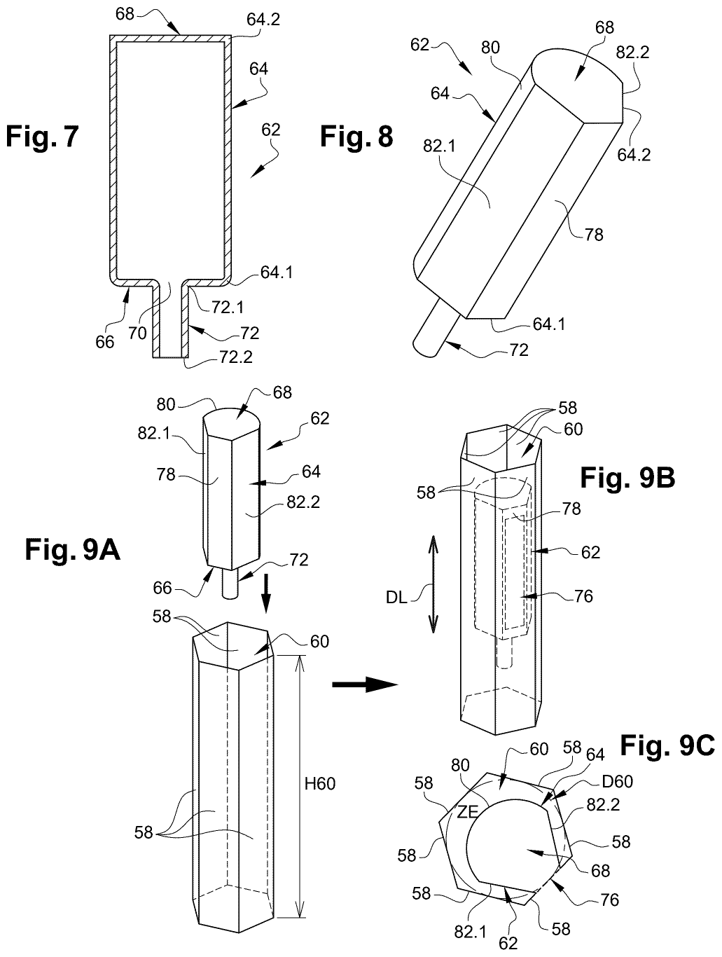

### DETAILED DESCRIPTION OF THE PREFERRED EMBODIMENTS

In FIG. 2, there has been represented an aircraft 30 that has a fuselage 32, two wings 34 disposed on respective opposite sides of the fuselage 32, and propulsion assemblies 36 fixed under the wings 34. Each propulsion assembly 36 comprises a nacelle 38 and a turbojet 40 positioned inside the nacelle 38.

In an embodiment seen in FIG. 3, the turbojet 40 comprises at the rear a primary jet pipe 42 through which gases burned in the turbojet 40 escape and that is delimited on the outside by an exterior wall 44 and on the inside by an interior wall 46 extended by a cone 48.

In one configuration, the exterior and interior walls 44, 46 each comprise at least one acoustic absorption structure 50.

Each acoustic absorption structure 50 comprises an exterior surface SE in contact with a medium in which acoustic waves propagate and an interior surface SI opposite the exterior surface SE.

Although described as applied to a primary jet pipe 42, the invention is not limited to that application. Thus, the acoustic absorption structure 50 can be positioned at the level of walls that have an exterior surface SE in contact with a medium in which sound waves propagate.

As depicted in FIGS. 3, 10 and 11, each acoustic absorption structure 50 comprises at least one cellular structure 52 situated between an acoustically resistive layer 54 permeable to sound waves and a reflective layer 56 impermeable to sound waves. The acoustically resistive layer 54 has a first face 54.1 corresponding to the exterior surface SE and a second face 54.2 oriented toward and connected to the cellular structure 52. The reflective layer 56 has a first face 56.1 corresponding to the interior surface SI and a second face 56.2 oriented toward and connected to the cellular structure 52.

The acoustically resistive layer 54, the reflective layer 56, the connection between the acoustically resistive layer 54 and the cellular structure 52 and the connection between the reflective layer 56 and the cellular structure 52 are not described in more detail because they can be identical to those of the prior art.

The cellular structure 52 extends between a first face 52.1 in contact with the acoustically resistive layer 54 and a second face 52.2 in contact with the reflective layer 56 and comprising a multitude of partitions 58, each of which has first and second edges positioned at the level of the first and second faces 52.1, 52.2, respectively. The partitions 58 are interconnected in such a manner as to delimit cells 60 discharging at the level of the first and second faces 52.1, 52.2.

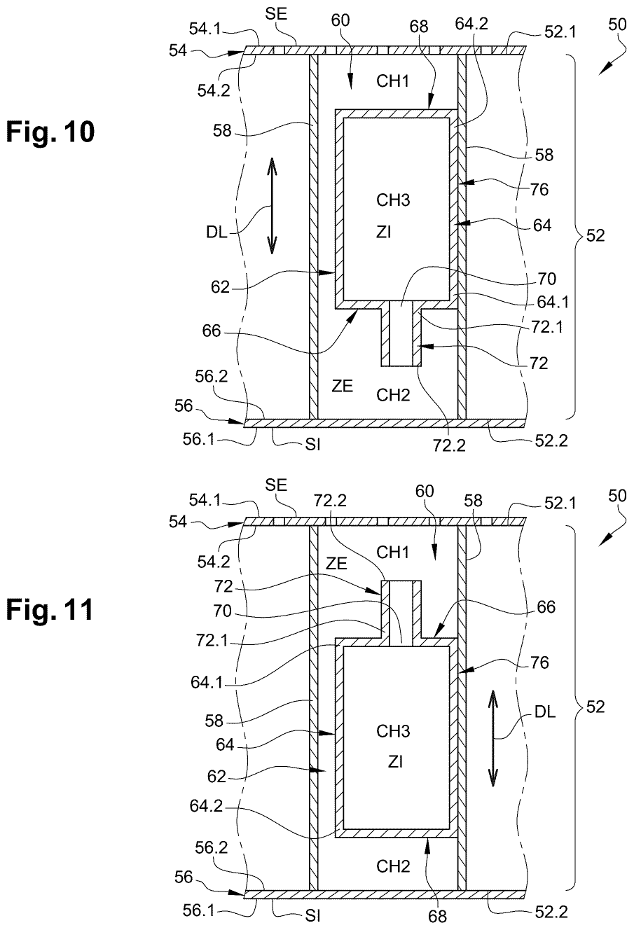

In an embodiment seen in FIGS. 4 and 9, the cellular structure 52 is delimited by a plurality of walls. As depicted in FIG. 10, each cell 60 is part of a honeycomb structure delimited by six substantially rectangular partitions 58 and has a hexagonal section with six identical sides. Each hexagonal cell 60 is inscribed in a circle of cell diameter D60. The cell diameter is between 9.6 and 19.1 mm. Each cell 60 has a cell height H60 (that corresponds to the distance separating the first and second faces 52.1, 52.2. The cell height H60 (FIG. 9A) is between 30 and 70 mm. Each rectangular partition 58 has a length equal to the cell height H60, between 30 and 70 mm, and a width between approximately 5 and 12 mm.

Of course, the invention is not limited to this embodiment of the cells 60. Each cell discharges at the level of first and second ends blocked by the acoustically resistive layer 54 and the reflective layer 56, respectively. Each cell 60 is delimited by at least one partition 58 parallel to a partition direction DL (FIG. 9B) substantially perpendicular to the acoustically resistive layer 54 and/or to the reflective layer 56.

As depicted in FIGS. 4, and 9A-9C to 11, the cellular structure 52 comprises at least one system of partitions positioned in a cell 60 of the cellular structure 52 and configured to divide it into a plurality of chambers. This system of partitions comprises a partitioning enclosure 62 positioned in a cell 60. In one configuration, the cellular structure 52 comprises a plurality of partitioning enclosures 62 each positioned in a cell 60. In one arrangement in at least one zone of the cellular structure 52 the latter comprises a partitioning enclosure 62 in each cell 60.

Each partitioning enclosure 62 comprises at least one tubular wall 64 substantially parallel to the partition direction DL that extends between the first and second ends 64.1, 64.2, a first transverse wall 66 connected to the tubular wall 64 at the level of the first end 64.1 and at least one second transverse wall 68 connected to the tubular wall 64 at the level of the second end 64.2. The tubular wall 64 and the first and second transverse walls 66, 68 are interconnected in a fluid-tight manner in order to separate an interior zone ZI and an exterior zone ZE (FIGS. 9C, 10, 11). The first and second transverse walls 66, 68 are substantially parallel to each other and to the acoustically resistive layer 54 and/or to the reflective layer 56, the first and second transverse walls 66, 68 being spaced from the acoustically resistive layer 54 and the reflective layer 56. Thus, the partitioning enclosure 62 is at a distance from the acoustically resistive layer 54 and the reflective layer 56.

The tubular wall 64 has a constant exterior cross section (in a plane parallel to the acoustically resistive layer 54 and/or to the reflective layer 56) between the first and second transverse walls 66, 68. The latter are substantially perpendicular to the tubular wall 64. The exterior cross section of the tubular wall 64 is smaller than the interior cross section of the cell 60 in which the partitioning enclosure 62 is positioned and greater than or equal to 75% of the interior cross section of the cell 60. This configuration enables a passage reduction to be obtained between the partitioning enclosure 62 and the partitions 58 of the cell 60, enabling first and second chambers CH1, CH2 to be delimited on respective opposite sides of the partitioning enclosure 62.

The partitioning enclosure 62 comprises at least one through-orifice 70 situated at the level of the tubular wall 64, the first transverse wall 66 or the second transverse wall 68. In one embodiment this through-orifice 70 is situated at the level of the first transverse wall 66 and substantially centered relative to the tubular wall 64.

In one configuration, the partitioning enclosure 62 comprises a pipe 72 that has a first end 72.1 connected to the first transverse wall 66 around the through-orifice 70 and a second end 72.2 at a distance from the first transverse wall 66. The pipe 72 is substantially parallel to the partition direction DL and approximately centered relative to the tubular wall 64. The pipe 72 has an inside diameter substantially equal to that of the through-orifice 70.

The pipe 72 and the through-orifice 70 have a passage section smaller than or equal to 25% of the interior cross section of the tubular wall 64. The pipe 72 has a constant cylindrical section between its two ends. The pipe 72 is substantially perpendicular to the first transverse wall 66. To give an idea of an order of magnitude, the pipe 72 has an inside diameter between 0.5 and 5 mm and a height (the distance between its ends) between 1 and 15 mm.

Each partitioning enclosure 62 is made in one piece, the first and second transverse walls 66, 68, the tubular wall 64 and the pipe 72 being produced in the same production step.

In one embodiment the partitioning enclosure 62 is made of plastic material.

In one mode of operation each partitioning enclosure 62 is produced by a blowing-extrusion-molding process using a mold 74 that has interior shapes identical to the exterior shapes of the partitioning enclosure 62.

This blowing-extrusion-molding process enables partitioning enclosures 62 to be produced at a high production rate. This process also makes it easy to be able to modify the section and/or the height of the tubular wall 64 by adjusting the shapes of the mold 74.

Of course, the invention is not limited to this mode of operation. By way of example, the partitioning enclosure 62 could be made by an injection molding process or any other process.

The cellular structure 52 of each partitioning enclosure 62 comprises at least one connection 76 connecting the tubular wall 64 of the partitioning enclosure 62 and at least one partition 58 delimiting the cell 60 in which the partitioning enclosure 62 is positioned. This connection 76 can be obtained by gluing, clipping, welding or otherwise.

In one embodiment, the tubular wall 64 comprises at least one flat 78 configured to be pressed against a partition 58 of the cellular structure 52 and connected to the latter by the connection 76. In one configuration, each flat 78 extends the full height of the tubular wall 64 (the dimension from one transverse wall 66, 68 to the other).

Connecting the tubular wall 64 to only one partition 58 of the cellular structure 52 makes it possible to preserve great flexibility at the level of the cellular structure 52. Alternatively, the partitioning enclosure 62 could comprise two flats connected to two partitions. To retain some flexibility the partitioning enclosure 62 is connected to at most two partitions 58 of the cell 60.

Additionally, the tubular wall 64 has a curved main part 80 that has an approximately circular arc section that extends the full height of the tubular wall 64 (the dimension from one transverse wall 66, 68 to the other).

In the case of hexagonal section cells 60 the tubular wall 64 comprises a main flat 78 and two secondary flats 82.1, 82.2 positioned on respective opposite sides of the main flat 78, connecting the latter to the curved main part 80. When the main flat 78 is fixed to one of the partitions 58 of the hexagonal cell 60, this solution enables a gap to be provided between on the one hand the other partitions 58 of the cell 60 and on the other hand the curved main part 80 and the secondary flats 82.1, 82.2 of the tubular wall 64.

To give an idea of an order of magnitude, the secondary flats 82.1, 82.2 are at an angle to each other between 40 and 140°. This angle is determined so that each of the secondary flats 82.1, 82.2 is substantially parallel to one of the partitions 58 of the cell 60. Furthermore, outside the main flat 78 that is pressed against one of the partitions 58 of the cell 60 the curved main part 80 and the two secondary flats 82.1, 82.2 are spaced from the partitions 58 of the cell 60 by a distance between 5 and 50% of the diameter D60 of the cell 60.

In one arrangement, the first or second transverse wall 66, 68 nearest the acoustically resistive layer 54 is spaced from the latter by a distance between 5 mm and 70% of the height H60 of the cell 60. For a cell height H60 between 30 and 70 mm the tubular wall 64 has a height (the dimension from one transverse wall 66, 68 to the other) between 10 and 40 mm.

Of course, the invention is not limited to this embodiment. Regardless of the embodiment, the cellular structure 52 comprises at least one partitioning enclosure 62 positioned in a cell 60 of the cellular structure 52 and connected to at least one partition 58 delimiting the cell 60, the partitioning enclosure 62 separating an interior zone ZI situated inside the partitioning enclosure 62 and an exterior zone ZE situated in the cell 60 and outside the partitioning enclosure 62, the partitioning enclosure 62 including at least one through-orifice 70 configured so that the interior and exterior zones ZE, ZI communicate.

In a first embodiment seen in FIG. 10, the first transverse wall 66 is oriented toward the reflective layer 56 and the second transverse wall 68 is oriented toward the acoustically resistive layer 54. In this case the pipe 72 discharges in the direction of the reflective layer 56.

In a second embodiment seen in FIG. 11, the first transverse wall 66 is oriented toward the acoustically resistive layer 54 and the second transverse wall 68 is oriented toward the reflective layer 56. In this case the pipe 72 discharges in the direction of the acoustically resistive layer 54.

In these two embodiments the partitioning enclosure 62 is preferably at a distance from the acoustically resistive layer 54 and the reflective layer 56 and spaced by a small distance from the partitions 58 of the cell 60 in which the partitioning enclosure 62 is positioned. Consequently, the partitioning enclosure 62 enables the cell 60 to be divided into a first chamber CH1 situated between the acoustically resistive layer 54 and the partitioning enclosure 62, a second chamber CH2 situated between the reflective layer 56 and the partitioning enclosure 62, and a third chamber CH3 situated inside the partitioning enclosure 62. This solution makes it possible to obtain three resonators configured to absorb acoustic waves over a broad spectrum.

In the first embodiment seen in FIG. 10, the acoustic waves pass through the acoustically resistive layer 54 and enter the first chamber CH1 which forms a first resonator configured to absorb acoustic waves at frequencies in a first range. The acoustic waves that are not absorbed pass between the partitions 58 of the cell 60 and the partitioning enclosure 62 and enter the second chamber CH2 which forms a second resonator configured to absorb acoustic waves at frequencies in a second range. The acoustic waves that are not absorbed enter the partitioning enclosure 62 via the pipe 72 forming a third resonator configured to absorb acoustic waves at frequencies in a third range.

In the second embodiment seen in FIG. 11, the acoustic waves pass through the acoustically resistive layer 54 and enter the first chamber CH1 which forms a first resonator configured to absorb acoustic waves at frequencies in a first range. Some acoustic waves that are not absorbed pass between the partitions 58 of the cell 60 and the partitioning enclosure 62 and enter the second chamber CH2 which forms a second resonator configured to absorb acoustic waves at frequencies in a second range. Other acoustic waves that are not absorbed enter the partitioning enclosure 62 via the pipe 72 forming a third resonator configured to absorb acoustic waves at frequencies in a third range.

In one mode of production, a method of producing an acoustic absorption structure comprises a step of producing a cellular structure 52 comprising first and second plane faces 52.1, 52.2, a step of inserting each partitioning enclosure 62 in a cell 60, a step of fixing the partitioning enclosure 62 inserted in the cell 60 to at least one partition 58 of the cell 60, a step of forming the cellular structure 52 and steps of fitting an acoustically resistive layer 54 and a reflective layer 56 produced after the step of fixing the partitioning enclosures 62 in the cells 60 of the cellular structure 52.

The partitioning enclosures 62 may be inserted out one by one, partitioning enclosure after partitioning enclosure, or more than one at a time, a plurality of partitioning enclosures being inserted simultaneously.

The step of inserting the partitioning enclosure 62 can be mechanized and/or carried out before or after the forming step.

As depicted in FIG. 4, the partitioning enclosures 62 can be connected to partitions 58 of the cellular structure 52 that are parallel to each other.

Of course, the invention is not limited to this way of producing the acoustic absorption structure 50.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An acoustic absorption structure comprising:
at least one cellular structure between an acoustically resistive layer and a reflective layer, the cellular structure comprising:
a first face in contact with the acoustically resistive layer,
a second face in contact with the reflective layer, and
a multitude of cells each discharging at a level of the first and second faces, each cell being delimited by at least one partition,
wherein the cellular structure comprises at least one partitioning enclosure positioned in one of the cells of the cellular structure and connected to at least one partition delimiting the cell,
said partitioning enclosure separating an interior zone inside the partitioning enclosure and an exterior zone situated in the cell and outside the partitioning enclosure, and
said partitioning enclosure including at least one through-orifice configured so that the interior and exterior zones communicate.

2. The acoustic absorption structure according to claim 1, wherein the partitions delimiting the cells are oriented in a partition direction, each partitioning enclosure comprises:
at least one tubular wall substantially parallel to the partition direction connected to at least one partition delimiting the cell, which extends between first and second ends,
a first transverse wall connected in fluid-tight manner to the tubular wall at a level of the first end, and
at least one second transverse wall connected in fluid-tight manner to the tubular wall at a level of the second end,
the through-orifice being situated at a level of the first transverse wall, and
the first and second transverse walls being spaced from the acoustically resistive layer and the reflective layer.

3. The acoustic absorption structure according to claim 2, wherein the cell in which the partitioning enclosure is positioned has an interior cross section and the tubular wall has an exterior cross section smaller than the interior cross section of the cell, and greater than or equal to 75% of the interior cross section of said cell.

4. The acoustic absorption structure according claim 2, wherein the partitioning enclosure comprises a pipe that has a first end connected to the first transverse wall around the through-orifice and a second end at a distance from the first transverse wall, the pipe having an inside diameter substantially equal to that of the through-orifice.

5. The acoustic absorption structure according to claim 4, wherein the tubular wall has an interior cross section and the pipe and the through-orifice have a passage section less than or equal to 25% of the interior cross section of the tubular wall.

6. The acoustic absorption structure according to claim 2, wherein each cell is delimited by a plurality of partitions and the partitioning enclosure is connected to at the most two partitions delimiting the cell.

7. The acoustic absorption structure according to claim 6, wherein the tubular wall comprises at least one flat configured to be pressed against and connected to a partition of the cellular structure.

8. The acoustic absorption structure according to claim 7, wherein the tubular wall has a constant exterior cross section between the first and second transverse walls, and includes a curved main part that has a circular arc section, a main flat and two secondary flats positioned on respective opposite sides of the main flat connecting the main flat to the curved main part.

9. The acoustic absorption structure according to claim 8, wherein each cell has a hexagonal section inscribed in a circle having a cell diameter and the curved main part and the two secondary flats are spaced from the partitions of the cell by a distance between 5 and 50% of the cell diameter.

10. The acoustic absorption structure according to claim 2, wherein the first and second transverse walls are oriented toward the reflective layer and the acoustically resistive layer, respectively.

11. The acoustic absorption structure according to claim 2, wherein the first and second transverse walls are oriented toward the acoustically resistive layer and the reflective layer, respectively.

12. An aircraft comprising at least one acoustic absorption structure according to claim 1.
